(19) United States
(12) Patent Application Publication
(10) Pub. No.: US 2025/0122758 A1
(43) Pub. Date: Apr. 17, 2025

(54) Motor-Driven Charging Device for Use in an Electric Vehicle

(71) Applicant: HBPO GmbH, Lippstadt (DE)

(72) Inventor: Reinhold Brückner, Herzebrock-Clarholz (DE)

(21) Appl. No.: 18/894,538

(22) Filed: Sep. 24, 2024

(30) Foreign Application Priority Data
Oct. 12, 2023 (DE) 10 2023 127 876.2

(51) Int. Cl. E05F 15/678; B60L 53/16; E05D 15/40

(52) U.S. Cl. CPC E05F 15/678; B60L 53/16; E05D 15/406; E05Y 2201/71; E05Y 2900/534

(57) ABSTRACT

The invention relates to a motor-driven charging device (2) for use in an electric vehicle, comprising a charging element (4), having a charging connection (6), a cover flap (10) for covering the charging connection (6) in a closed state of the motor-driven charging device (2), a motor (12) operatively connected to the cover flap (10) and the charging element (4) for driving an opening movement and a closing movement of the cover flap (10) and the charging element (4), a power transmission element (14) for transmitting a motor power of the motor (12) for carrying out the opening movement and the closing movement of the cover flap (10) and the charging element (4), a guide elements (16) for guiding the cover flap (10) and the charging element (4) along a movement path during the opening movement and the closing movement of the cover flap (10) and the charging element (4), the cover flap (10) and the charging element (4) being arranged relative to one another and kinematically coupled to one another in such a way that the cover flap (10) and the charging element (4) can be moved simultaneously in opposite directions during the opening movement and the closing movement in a motor-driven manner, such that the charging element (4) can be moved in an open state of the motor-driven charging device (2) into the position which the cover flap (10) has in the closed state of the motor-driven charging device (2).

The present invention relates to a motor-driven charging device for use in an electric vehicle and to an electric vehicle with such a motor-driven charging device.

Charging devices for covering and releasing charging ports are known from the state of the art and are primarily used in automotive engineering. The known charging devices have a charging connection and a cover flap for covering and releasing the charging connection. A disadvantage of the known devices, in addition to the often low user comfort when covering and releasing, is in particular the relatively high space requirement of electric vehicles during a charging process. The high space requirement results from the fact that the cover flaps of the known charging devices are generally pivoted outwards when charging connections are released and often protrude from the vehicle at a 90° angle when in an open state.

The cover flaps protruding from the vehicle represent an obstacle that is sometimes difficult for pedestrians to see and with which they can collide. This can lead not only to personal injury but also to damage to the loading equipment. In addition, the cover flaps protruding from the vehicle are often victims of vandalism, as they can easily be knocked off by a vehicle due to their unfavorable angle.

Although charging devices are also known that open at least partially into the interior of electric vehicles, so that they require less space and are also less easily damaged, the charging connections of such charging devices are difficult to recognize and reach, especially in poor lighting conditions, so that a charging process with such a charging device has only a low level of user comfort. In addition, these charging devices are susceptible to icing and soiling, as the internal arrangement of the vehicle results in a relatively large soiling surface during a charging process. Particularly at temperatures below freezing point, the problem arises that melting precipitation on the heated charging plug drips onto the surface and freezes there, resulting in stubborn icing. This is not only questionable from a comfort point of view, but also from a safety point of view.

It is therefore the object of the present invention to at least partially remedy the above-mentioned disadvantages of known charging devices for covering and releasing charging connections. In particular, it is the object of the invention to provide a charging device for use in an electric vehicle which is easy and inexpensive to manufacture and maintain, requires a minimum of space and at the same time offers safe charging with a high level of charging convenience.

The above object is solved by a device with the features of the independent device claim 1 and an electric vehicle with the features of claim 16. Further features and details of the invention are disclosed in the dependent claims, the description and the drawings. Technical features disclosed for the device according to the invention also apply in connection with the electric vehicle according to the invention and vice versa, so that reference is or can always be made reciprocally with regard to the disclosure of the individual aspects of the invention. Useful embodiments of the invention are described in the dependent claims.

According to the invention, a motor-driven charging device for use in an electric vehicle is provided. Here, the motor-driven charging device according to the invention comprises a charging element having a charging connection, a cover flap for covering the charging connection in a closed state of the motor-driven charging device, a motor operatively connected to the cover flap and the charging element for driving the opening movement and a closing movement of the cover flap and the charging element, a power transmission element for transmitting a motor power of the motor to perform the opening movement and the closing movement of the cover flap and the charging element, a guide element for guiding the cover flap and the charging element along a movement path during the opening movement and the closing movement of the cover flap and the charging element, wherein the cover flap and the charging element being arranged relative to one another and kinematically coupled to one another in such a way that the cover flap and the charging element can be moved simultaneously in opposite directions during the opening movement and the closing movement, driven by the motor, in such a way that the charging element, in an open state of the motor-driven charging device, can be moved into the position which the cover flap has in the closed state of the motor-driven charging device.

In particular, the charging device in question can be intended for use in at least partially electrically powered motor vehicles. In addition to use in at least partially electrically powered passenger cars or trucks, the charging device according to the invention can also be used in other at least partially electrically powered elements of transportation, such as forklift trucks, cranes, ships or flying objects. The charging device in question can be formed in particular in the form of a charging device for covering and releasing a charging connection.

In the context of the invention, an electric vehicle can also be understood—as already mentioned above—as a vehicle that can only be partially or temporarily operated electrically, such as a hybrid vehicle or the like. In this context, a charging connection can be understood in particular to mean the receiving device for receiving a charging plug. In the context of the invention, a cover flap can also be understood to mean a flat, planar flap or plate. The cover flap can have various shapes, e.g. round, oval, rectangular, elliptical or similar shapes. Advantageously, the motor-driven charging device in question can be configured in such a way that the bodywork at least partially covers the cover flap from the outside of the vehicle when the charging device is in an open state. The feature that the cover flap is motor-driven into a recess in the body and movable along the body of the electric vehicle during the opening or closing movement can be understood in particular to mean that the cover flap is motor-driven into a recess in the body during the opening or closing movement and can then be moved behind the body along the body of the electric vehicle.

Compared with known charging devices for covering and releasing a charging connection, the charging device according to the invention is characterized in particular by the fact that the cover flap and the charging element are arranged relative to one another and are kinematically coupled to one another in such a way that the cover flap and the charging element can be moved simultaneously in opposite directions during the opening movement and the closing movement in a motor-driven manner, such that the charging element can be moved in an open state of the motor-driven charging device into the position which the cover flap has in the closed state of the motor-driven charging device. In this way, it is possible in particular that an opening on a body of an electric vehicle can be closed, preferably fluid-tightly closed, through the cover flap when the motor-driven charging device is closed and the opening can be closed, preferably fluid-tightly closed, through the charging element when the motor-driven charging device is in an open state. In particular, this enables safe loading with a high level of loading convenience at low cost.

With regard to a stable, structurally simple to manufacture, smooth-running and flexibly adaptable power transmission from a motor to a cover flap and a charging element, it can advantageously be provided according to the invention that the power transmission element is configured in several parts and has at least one upper and lower gear wheel, preferably a first and second upper gear wheel and a first and second lower gear wheel being provided, the lower gear wheels in particular being connected to one another via a connecting shaft. The upper gearwheels, just like the lower gearwheels, can preferably be of the same configuration, in particular mirror-symmetrical to one another, in order to enable a particularly precise and targeted selectable movement. The upper gearwheels can be connected via the lower gearwheels, for example, which can then be connected to each other via a connecting shaft.

In the context of a structurally simple to manufacture and low-wear configuration of a motor-driven charging device for effective power transmission, it can advantageously also be provided according to the invention that the power transmission element has a guide pin for insertion into a corresponding recess in the motor, the guide pin preferably being arranged fixedly on an upper or lower gearwheel, the guide pin being formed in particular in one piece with the upper or lower gearwheel. The guide pin can preferably be arranged on the outside or terminally of the upper or lower gearwheel, so that a motor can be arranged on the outside in a space-saving manner and can independently perform the entire drive of an opening movement and a closing movement. This is advantageous both for cost reasons and for reasons of space-saving arrangement.

With regard to a compact and stable arrangement for precise guidance of the cover flap and the charging element along a movement path, it can also be advantageous in this case that the power transmission element is arranged directly on the guide element, preferably connected directly to the guide element.

As an alternative to a several part power transmission element, with a focus to a particularly space-saving, lightweight and simple configuration of the motor-driven charging device in question, it is also possible for the power transmission element to be configured in one piece, with the power transmission element preferably being configured in the form of a connecting shaft. In this case, a guide pin for insertion into a corresponding recess in the motor can preferably be arranged terminally of the connecting shaft. The connecting shaft can then be connected directly to the guide element.

With regard to a stable movement of the cover flap and the charging element along a movement path, which is easy to manufacture by configuration and can be precisely defined, it may advantageously be further provided that the guide element is configured in several parts and has at least one control disk for guiding the cover flap and the charging element along a movement path, wherein the control disk has at least one integrated control channel for inserting control pins, wherein the guide element preferably has at least two control disks, which are arranged in particular mirror-symmetrically to each other, spaced apart from each other. With regard to a compact arrangement and safe control of a movement, preferably more than one control channel can be arranged within a control disk. For example, two control disks can be provided, each with two control channels, whereby preferably one control channel of the respective control disk can be provided for controlling the cover flap and the other control channel for controlling the charging element. The control disks can, for example, be moved synchronously with each other and determine the movement of the cover flap and the charging element via the guidance of control pins in the control channels around a fixed pivot point.

With regard to a stable movement of the cover flap and the charging element along a movement path, which is easy to manufacture by configuration and can be precisely defined, it can advantageously also be provided in the present case that the guide element has a plurality of levers for guiding the cover flap and the charging element along a movement path, the levers preferably having a control pin arranged terminally for engaging in a control channel of a control disk or for engaging in a guide channel arranged terminally. Preferably, at least two levers for guiding the cover flap and the charging element along a movement path can be arranged on a first and on a second opposite side of the motor-driven charging device in question, wherein, for example, one of the levers engages with a pin arranged terminally in a control channel of a control disk. The other lever can then engage in a further guide channel, which runs, for example, in a lateral housing channel. In this way, for example, a movement of the loading lid can be positively controlled via the levers and control pins, which engage in the control channel and a laterally arranged guide channel, so that a cover flap can be moved safely around a charging element that is also moving.

In order to keep the charging element in question stable in a loading position, it can advantageously also be provided that the guide element has a locking cam for blocking a movement of the cover flap in an open state of the motor-driven charging device, the locking cam preferably interacting with a shape-corresponding receiving section of the charging element when a movement is blocked, the locking cam being arranged in particular on the control disk. The shape-corresponding receiving section of the charging element is preferably positioned in such a way that a circular arc acts around the control pin involved in the direction of the pivot point.

With regard to a stable movement of the cover flap and the charging element along a movement path, which is easy to manufacture by configuration and can be precisely defined, it may advantageously be further provided that the cover flap and/or the charging element have receiving pins for receiving levers for guiding the cover flap and the charging element along a movement path and/or control pins for engaging in a control channel of a control disk or for engaging in a guide channel arranged terminally.

With regard to a movement of the cover flap and the charging element along a movement path that is easy to manufacture and can be precisely defined, it can advantageously also be provided that the cover flap and/or the charging element is configured as a four-bar linkage and can be guided along a movement path via a four-bar linkage drive, whereby a first and second lever is arranged on a first and second opposite side of the cover flap and/or the charging element to form the four-bar linkage. For example, a cover flap and/or the charging element can each be mounted via two laterally arranged receiving pins, whereby two levers are then rotatably mounted on the right and left via receiving pins. Alternatively, the movement of the cover flap and/or the charging element can also be extended using additional levers, e.g. to generate higher forces. For example, the levers can be arranged according to the toggle lever principle or be characterized by a relocation of the control pin to one of the levers. Although this requires a larger installation space, it guarantees a higher force.

In order to prevent unauthorized opening (or closing) of the motor-driven charging device in question, it may advantageously be provided that the integrated control channel has a dead center section for receiving a control pin arranged on the cover flap, wherein the dead center section is preferably arranged terminally inside the integrated control channel, wherein the dead center section is configured in particular to block a movement of the cover flap starting from a closed and/or opened state of the motor-driven charging device on the basis of an interaction with a control pin arranged on the cover flap. The integrated control channel can be arranged and configured opposite the arrangement of a control pin arranged on the cover flap in such a way that the control disk rotates beyond the point of closing in a closed state of the motor-driven charging device. In this area, the control channel is configured with a constant radius to the pivot point so that the cover flap is blocked against unauthorized opening (or closing).

Likewise, as part of a stable configuration to ensure a precisely determinable movement of the cover flap and the charging element along a movement path, it may advantageously also be provided that a housing is provided to accommodate the cover flap and the charging element, wherein the housing is preferably formed in several parts, wherein the housing in particular has a first and second guide channel arranged terminally for additional guidance of the cover flap and the charging element along a movement path. The housing can advantageously comprise at least two parts that are mirror-symmetrical to each other and can, for example, be clipped together.

As part of a structurally simple solution for a stable, precise and reliable drive of a motor-driven charging device, it may advantageously be provided in particular that the motor is formed in the form of an actuator, preferably in the form of a rotary actuator. In the context of its intended use for driving an opening and closing movement of a cover flap, the motor provided according to the invention can be configured in particular to be able to transmit a torque of <2 N.

To protect a charging element, in particular to prevent the ingress of dirt and water into the interior of an electric vehicle or into the motor-driven charging device, it can also be advantageous if the charging element has a housing and a seal arranged around the housing to seal an interior area of an electric vehicle from a vehicle exterior area in an open state of the motor-driven charging device. The seal can preferably comprise a plastic, for example silicone, polyurethane, polyvinyl chloride, polyetrafluoroethylene or rubber. It is also understood that the charging device in question can also be provided with a corresponding seal.

In order to be able to carry out a charging process even in poor visibility conditions, the invention can advantageously further provide that at least one lighting device is provided for illuminating a charging connection and/or for displaying information, the lighting device preferably being in the form of at least one, in particular a plurality of LEDs. In particular, the lighting device can also illuminate the area immediately surrounding the charging connection. Preferably, the activation process of the lighting device can be coupled with an opening or closing process of the cover flap. Furthermore, it is conceivable that the lighting device displays information, for example about a current charging status, a charging authorization, a charging process currently being carried out, a completed charging process or similar, for example via differently colored LEDs or similar.

Another object of the invention is an electric vehicle comprising a motor-driven charging device as described above. The electric vehicle according to the invention thus has the same advantages as those already described in detail in relation to the motor-driven charging device according to the invention. The charging connection can preferably be formed to accommodate or introduce charging plugs of European standards, such as standard type 2 plugs, CCS2 plugs, but also for charging plugs of Japanese, Chinese or American standards. that the charging connection is located on the side and/or front area and/or underbody of the electric vehicle.

With regard to an advantageous arrangement of the charging connection, it may be provided that the charging connection is arranged on the side and/or on the front area and/or on the underbody of the electric vehicle. When the charging connection is arranged on the side of the electric vehicle, the charging connection can preferably be arranged inside the mudguard or the rear wing, whereas the charging connection can preferably be arranged inside the front-end module, in particular inside the radiator grille, when the charging connection is arranged on the front area.

Further advantages, features and details of the invention are shown in the following description, in which embodiments of the invention are described in detail with reference to the drawings. The features mentioned in the claims and in the description may each be essential to the invention individually or in any combination.

It shows:

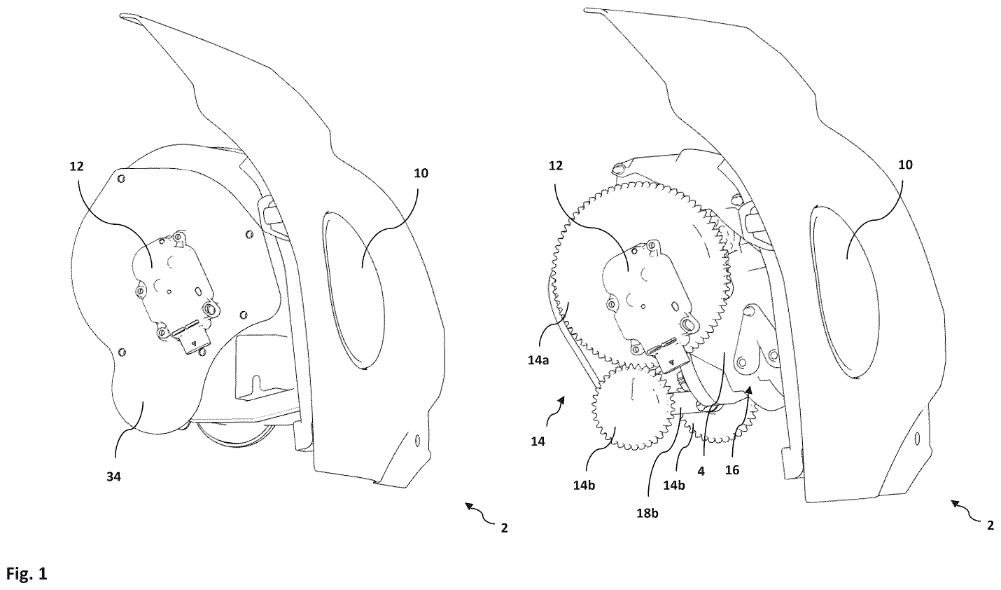

FIG. 1 a schematic representation of a motor-driven charging device according to the invention for use in an electric vehicle in a closed state, with housing (left) and without housing (right), in each case according to a first embodiment,

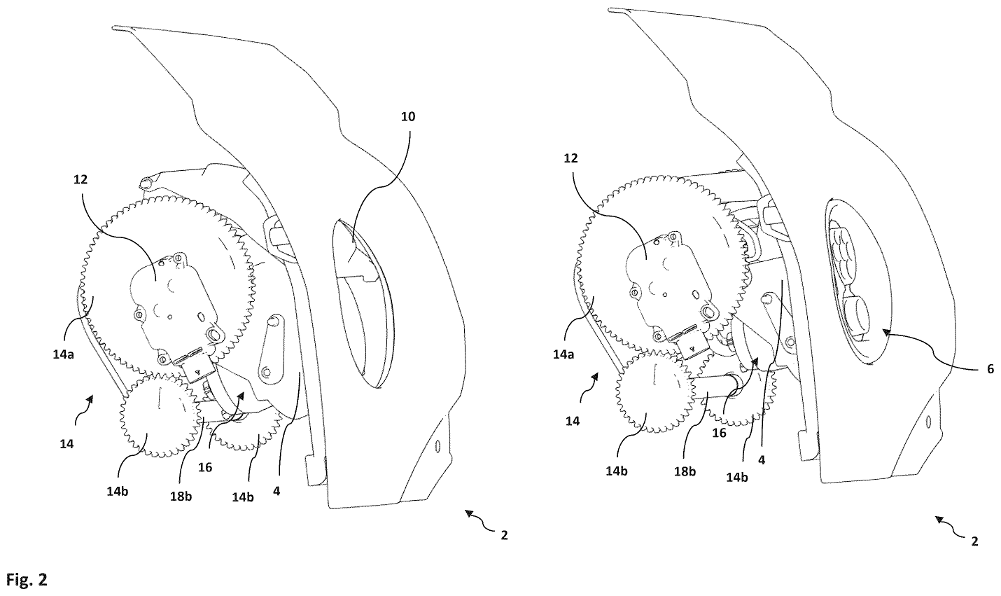

FIG. 2 a schematic representation of a motor-driven charging device according to the invention for use in an electric vehicle without a housing in a partially open state (left) and a fully open state (right) according to the first embodiment,

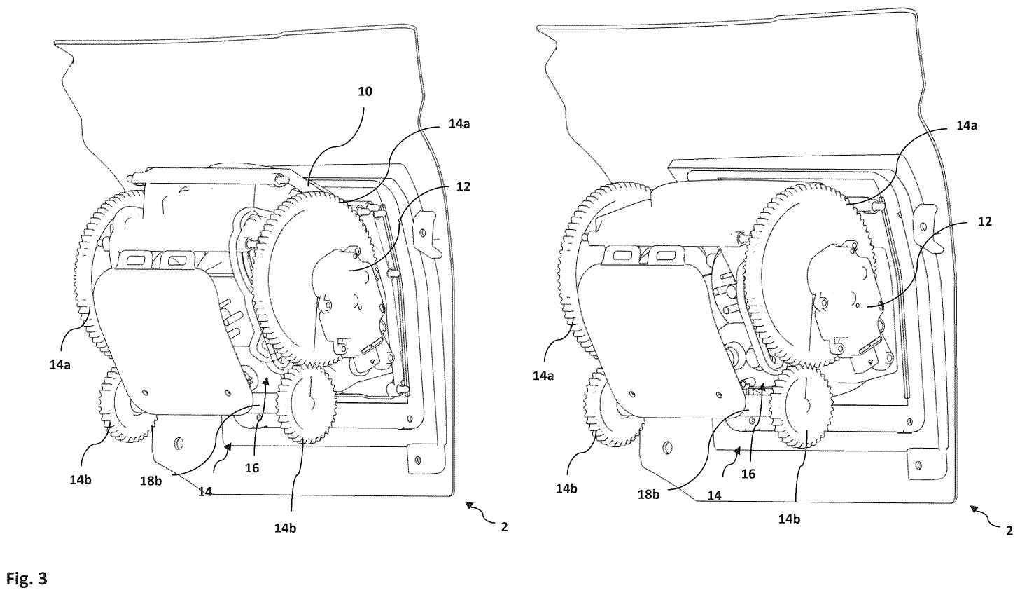

FIG. 3 a schematic representation of a motor-driven charging device according to the invention for use in an electric vehicle without a housing in a partially open state (left) and a fully open state (right) according to the first embodiment, each shown from the rear,

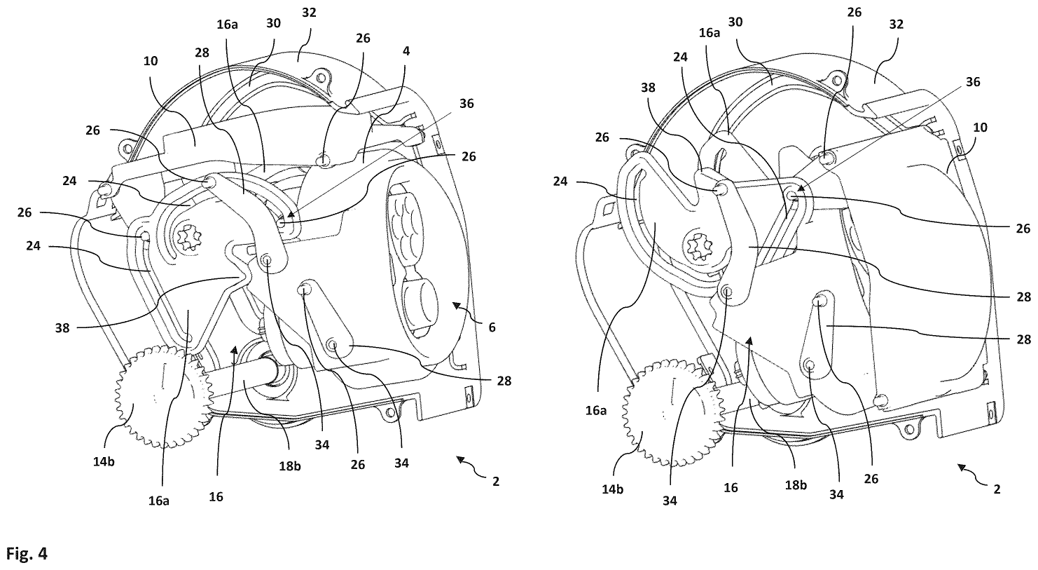

FIG. 4 a schematic representation of a part of the motor-driven charging device according to the invention, shown from the side, in an open state (left) and a closed state (right) according to the first embodiment,

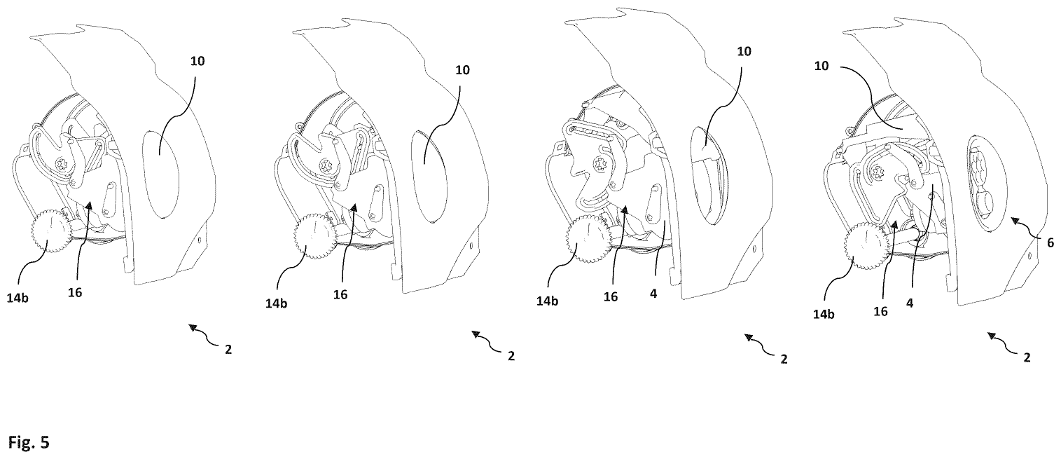

FIG. 5 a further schematic representation of a part of the motor-driven charging device according to the invention according to the first embodiment from the side during an opening process at four different times in each case,

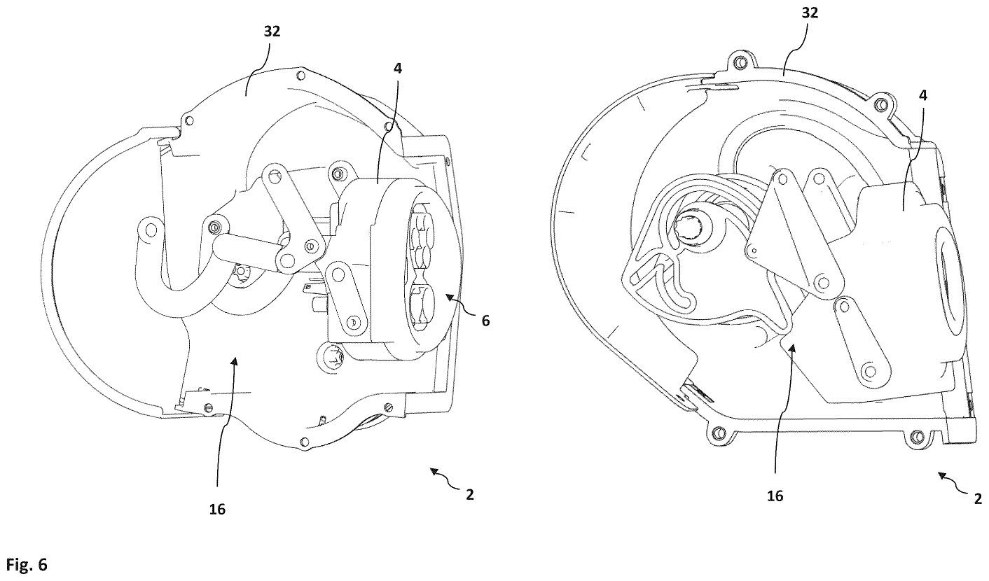

FIG. 6 a schematic representation of a motor-driven charging device for use in an electric vehicle in an open state according to a second and third embodiment,

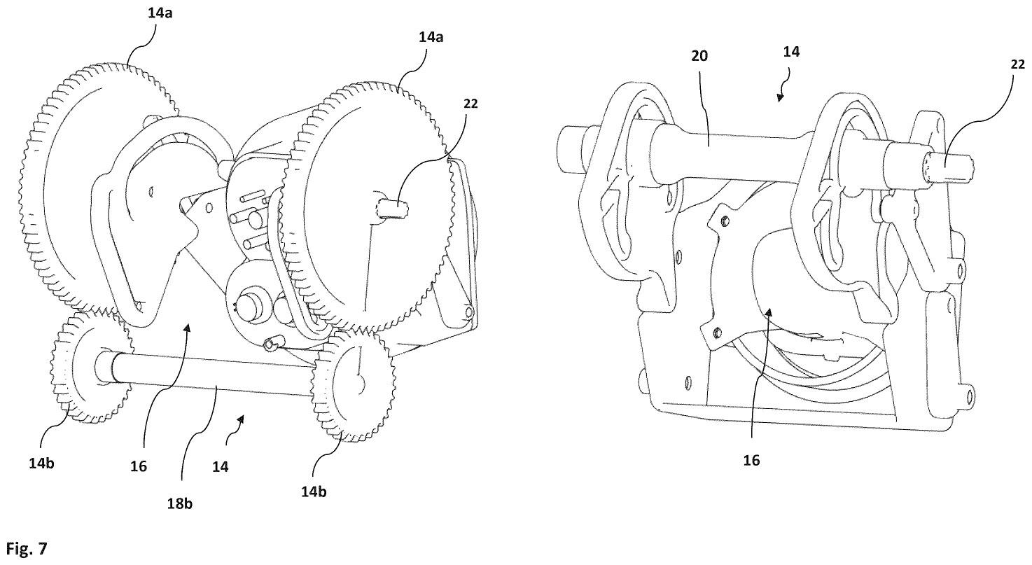

FIG. 7 a schematic representation of a power transmission element and a guide element for a motor-driven charging device according to the invention according to a first and a further embodiment,

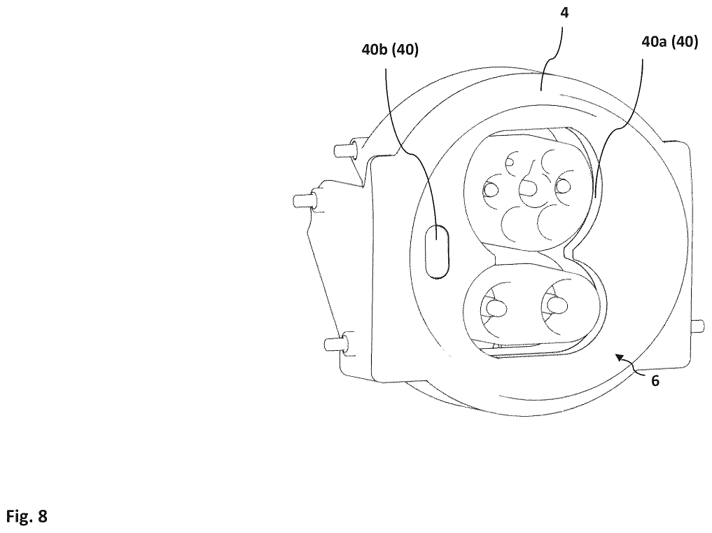

FIG. 8 a schematic representation of a charging element of a motor-driven charging device according to the invention for use in an electric vehicle.

FIG. 1 shows a schematic representation of a motor-driven charging device 2 according to the invention for use in an electric vehicle in a closed state, with housing 34 (left) and without housing 34 (right), in each case according to a first embodiment.

FIG. 2 shows a schematic representation of a motor-driven charging device 2 according to the invention for use in an electric vehicle without housing 34 in a partially open state (left) and a fully open state (right) according to the first embodiment.

FIG. 3 shows a schematic representation of a motor-driven charging device 2 according to the invention for use in an electric vehicle without housing 34 in a partially open state (left) and a fully open state (right) according to the first embodiment, each shown from the rear.

As can be seen from FIGS. 1 to 3, the motor-driven charging device 2 comprises a charging element 4 having a charging connection 6, a cover flap 10 for covering the charging connection 6 in a closed state of the motor-driven charging device 2, a motor 12 operatively connected to the cover flap 10 and the charging element 4 for driving an opening movement and a closing movement of the cover flap 10 and the charging element 4, a power transmission element 14 for transmitting a motor power of the motor 12 for carrying out the opening movement and the closing movement of the cover flap 10 and the charging element 4, a guide element 16 for guiding the cover flap 10 and the charging element 4 along a movement path during the opening movement and the closing movement of the cover flap 10 and the charging element 4, the cover flap 10 and the charging element 4 being arranged relative to one another and kinematically coupled to one another in such a way that the cover flap 10 and the charging element 4 can be moved simultaneously in opposite directions during the opening movement and the closing movement in a motor-driven manner in such a way that the charging element 4, in an open state of the motor-driven charging device 2, can be moved into the position which the cover flap 10 has in the closed state of the motor-driven charging device 2.

As can also be seen, the power transmission element 14 is configured in several parts and has a first and second upper gearwheel 14a and a first and second lower gearwheel 14b, the lower gear wheels 14b being connected to one another via a connecting shaft 18b.

The motor 12 is in the form of an actuator, in this case a rotary actuator.

FIG. 4 shows a schematic representation of a part of the motor-driven charging device 2 according to the invention, shown from the side, in an open state (left) and a closed state (right) according to the first embodiment.

As can be seen in FIG. 4, the guide element 16 is made up of several parts and has two control disks 16a for guiding the cover flap 10 and the charging element 4 along a movement path, the control disks 16a having an integrated control channel 24 for inserting control pins 26.

In addition, the guide element 16 has a plurality of levers 28 for guiding the cover flap 10 and the charging element 4 along a movement path, which have control pins 26 arranged terminally for engaging in a control channel 24 of the control disks 16a or for engaging in a guide channel 30 arranged terminally.

The guide element 16 also has a locking cam 38 for blocking a movement of the cover flap 10 in an open state of the motor-driven charging device 2, which is arranged on the control disk 16a and interacts with a shape-corresponding receiving section of the charging element 4.

The cover flap 10 and the charging element 4 also have receiving pins 34 for receiving levers 28 for guiding the cover flap 10 and the charging element 4 along a movement path and control pins 26 for engaging in the control channel 24 of the control disks 16a or for engaging in a guide channel 30 arranged terminally.

As can be seen in FIG. 4, the cover flap 10 is configured as a four-bar linkage, with a first and second lever 28 being arranged on a first and second opposite side of the cover flap 10 respectively to form the four-bar linkage.

The integrated control channel 24 further comprises a dead center section 36 for receiving a control pin 26 arranged on the cover flap 10, wherein the dead center section 36 is arranged terminally within the integrated control channel 24 and is configured to block a movement of the cover flap 10 starting from a closed and/or opened state of the motor-driven charging device 2 on the basis of an interaction with a control pin 26 arranged on the cover flap 10.

Furthermore, according to FIG. 4, a part of a housing 32 for receiving the cover flap 10 and the charging element 4 is shown, which is configured in several parts and has a first and second guide channel 30 arranged terminally for additional guidance of the cover flap 10 and the charging element 4 along a movement path.

FIG. 5 shows a further schematic representation of a part of the motor-driven charging device 2 according to the first embodiment example from the side during an opening process at four different times in each case.

As can be seen from FIG. 5, the motor-driven charging device 2 according to the invention is shown in a closed, a slightly open, a half-open and a fully open state. As can be seen from the figures, the cover flap 10 and the charging element 4 are arranged relative to one another and kinematically coupled to one another in such a way that the cover flap 10 and the charging element 4 can be moved simultaneously in opposite directions in the opening movement (from left to right) and the closing movement (from right to left), driven by the motor, in such a way that the charging element 4 can be moved in an open state of the motor-driven charging device 2 into the position which the cover flap 10 has in the closed state of the motor-driven charging device 2.

FIG. 6 shows a schematic representation of a motor-driven charging device 2 for use in an electric vehicle in an open state according to a second and third embodiment.

As can be seen in FIG. 6, the movement of the cover flap and/or the charging element can also be extended using additional levers, e.g. to generate higher forces. For example, the levers can be arranged according to the toggle lever principle (left) or characterized by a relocation of the control pin to one of the levers (right). Although this requires a larger installation space, it guarantees a higher force.

FIG. 7 shows a schematic representation of a power transmission element 14 and a guide element 16 for a motor-driven charging device 2 according to the invention in accordance with a first and a further embodiment example.

As can be seen in FIG. 7 (left), the power transmission element 14 has a guide pin 22 for insertion into a corresponding recess in the motor 12, wherein the guide pin 22 is fixedly arranged on the upper gearwheel 14a and is formed in one piece with the upper gearwheel 14a. The power transmission element 14 is directly connected to the guide element 16.

As can be seen in FIG. 7 (right), the power transmission element 14 according to the further embodiment example can also be configured in one piece and in the form of a connecting shaft 20.

FIG. 8 shows a schematic representation of a charging element of a motor-driven charging device 2 according to the invention for use in an electric vehicle.

As can be seen in FIG. 8, the charging element 4 has a lighting device 40 in the form of a light ring 40a for illuminating a charging connection and in the form of a status display 40b, e.g. for displaying information.

Through the motor-driven charging device 2 according to the invention, it is possible in particular to guarantee a safe and convenient charging process with minimum space requirements in a structurally simple and cost-effective manner.

### LIST OF REFERENCE SYMBOLS

2 Motor-driven charging device
4 Charging element
6 Charging connection
10 Cover flap
12 Motor
14 Power transmission element
14a Upper gearwheel
14b Lower gearwheel
16 Guide element
16a Control disk
18b Connecting shaft
20 Connecting shaft
22 Guide pin
24 Control channel
26 Control pin
28 Lever
30 Guide channel
32 Housing
34 Receiving pin
36 Dead center section
38 Locking cam
40 Lighting device
40a Light ring
40b Status display

1. A motor-driven charging device for use in an electric vehicle, comprising:
a charging element, having a charging connection,
a cover flap for covering the charging connection in a closed state of the motor-driven charging device,
a motor operatively connected to the cover flap and the charging element for driving an opening movement and a closing movement of the cover flap and the charging element,
a power transmission element for transmitting a motor power of the motor to perform the opening movement and the closing movement of the cover flap and the charging element,
a guide element for guiding the cover flap and the charging element along a movement path during the opening movement and the closing movement of the cover flap and the charging element,
wherein
the cover flap and the charging element are arranged relative to one another and are kinematically coupled to one another in such a way that the cover flap and the charging element can be moved simultaneously in opposite directions during the opening movement and the closing movement, driven by the motor, in such a way that the charging element, in an open state of the motor-driven charging device, is movable into the position which the cover flap has in the closed state of the motor-driven charging device.

2. The motor-driven charging device according to claim 1,
wherein
the power transmission element is configured in several parts and has at least one upper and lower gearwheel.

3. The motor-driven charging device according to claim 1,
wherein
the power transmission element has a guide pin for insertion into a corresponding recess in the motor.

4. The motor-driven charging device according to claim 1,
wherein
the power transmission element is arranged directly on the guide elements.

5. The motor-driven charging device according to claim 1,
wherein
the power transmission element is configured in one piece, the power transmission element.

6. The motor-driven charging device according to claim 1,
wherein
the guide element is constructed in several parts and has at least one control disk for guiding the cover flap and the charging element along a movement path, the control disk having at least one integrated control channel for inserting control pins.

7. The motor-driven charging device according to claim 1,
wherein
the guide element has a plurality of levers for guiding the cover flap and the charging element along a movement path.

8. The motor-driven charging device according to claim 1,
wherein
the guide element has a locking cam for blocking a movement of the cover flap in an open state of the motor-driven charging device.

9. The motor-driven charging device according to claim 1
wherein
at least the cover flap or the charging element have at least receiving pins for receiving levers for guiding the cover flap and the charging element along a movement path or control pins for engaging in a control channel of a control disk or for engaging in a guide channel arranged terminally.

10. The motor-driven charging device according to claim 1,
wherein
at least the cover flap or the charging element is configured as a four-bar linkage and can be guided along a movement path via a four-bar linkage drive, wherein in each case a first and second lever for forming the four-bar linkage being arranged in each case on a first and second opposite side of at least the cover flap or the charging element.

11. The motor-driven charging device according to claim 1,
wherein
the integrated control channel has a dead center section for receiving a control pin arranged on the cover flap.

12. The motor-driven charging device according to claim 1
wherein
a housing is provided for receiving the cover flap and the charging element.

13. The motor-driven charging device according to claim 1
wherein
the motor is formed in the form of an actuator.

14. The motor-driven charging device according to claim 1,
wherein
the charging element has a housing and a seal arranged around the housing for sealing an interior region of an electric vehicle with respect to a vehicle exterior region in an open state of the motor-driven charging device.

15. The motor-driven charging device according to claim 1,
wherein
at least one lighting device is provided at least for illuminating a charging connection or for displaying information.

16. An electric vehicle comprising a motor-driven charging device according to claim 1.

17. The electric vehicle according to claim 16,
wherein
the charging connection is arranged at least on the side or on the front area or on the underbody of the electric vehicle.

18. The motor-driven charging device according to claim 6,
wherein
the guide elements having at least two control disks which are arranged mirror-symmetrically with respect to one another, spaced apart from one another.

19. The motor-driven charging device according to claim 7,
wherein
the levers having a control pin arranged terminally for engaging in a control channel of a control disk or for engaging in a guide channel arranged terminally.

20. The motor-driven charging device according to claim 8,
wherein
the locking cam interacting with a shape-corresponding receiving section of the charging element when a movement is blocked wherein the locking cam being arranged on the control disk.
